(19) United States
(12) Patent Application Publication
(10) Pub. No.: US 2024/0193683 A1
(43) Pub. Date: Jun. 13, 2024

(54) MONEY EXCHANGE RESERVATION METHOD USING ON-SITE MONEY EXCHANGE KIOSK

(71) Applicant: OODDY CO., LTD, Seoul (KR)

(72) Inventor: Bong Kyun KWON, Gyeonggi-do (KR)

(21) Appl. No.: 18/286,098

(22) PCT Filed: Mar. 25, 2022
(86) PCT No.: PCT/KR2022/004268

§ 371 Date: Oct. 6, 2023

(30) Foreign Application Priority Data
Apr. 6, 2021 (KR) 10-2021-0044500

(51) Int. Cl. G06Q 40/04; G06Q 10/02

(52) U.S. Cl. CPC G06Q 40/04; G06Q 10/02

(57) ABSTRACT

The present disclosure relates to a money exchange reservation method and, more specifically, to a money exchange reservation method enabling: a user to make a reservation for a money exchange through an application installed in a user terminal before visiting a visiting country, and then receive a foreign currency necessary in the visiting country through a money exchange kiosk provided in the visiting country, so as to provide a money exchange service, with money of the corresponding country, to the user visiting the corresponding country while the money exchange kiosk has only the foreign currency of the corresponding country, and thus costs and effort for managing and operating the money exchange kiosk can be reduced; and the user to easily receive the money exchange service through a desired money exchange kiosk at the necessary time after arriving at the visiting country, without the need to exchange foreign currencies in advance or move while in possession of the exchanged currency.

### TECHNICAL FIELD

The present disclosure relates to a money exchange reservation method and, more specifically, to a money exchange reservation method enabling: a user to make a reservation for a money exchange through an application installed in a user terminal before visiting a visiting country, and then receive a foreign currency necessary in the visiting country through a money exchange kiosk provided in the visiting country, so as to provide a money exchange service, with money of the corresponding country, to the user visiting the corresponding country while the money exchange kiosk has only the foreign currency of the corresponding country, and thus costs and effort for managing and operating the money exchange kiosk can be reduced; and the user to easily receive the money exchange service through a desired money exchange kiosk at the necessary time after arriving at the visiting country, without the need to exchange foreign currencies in advance or move while in possession of the exchanged currency.

### BACKGROUND

Regarding money exchange, various online money exchange methods have been proposed recently, and until now, currency exchange business was considered a unique business of banks, but with the passage of the revised Enforcement Decree of the Foreign Exchange Transactions Act in 2018, fintech companies have been added to the scope of industries that can conduct foreign exchange business, and the introduction of a new money exchange service method is expected to revitalize fintech startups and improve consumer convenience at the same time.

Looking at an example of a conventional online money exchange method, a user requesting money exchange applies for money exchange online, and when a confirmation number is received by text or messenger, the user visits a designated branch on a designated date with an ID card and receives money. In this case, if the user sets the pickup location to an airport branch, the user can also receive money at the bank branch at the airport on the day of departure.

Looking at another example of a conventional online money exchange method, if a user who requests money exchange deposits money to a currency exchange company online and reserves the location and time the user wants to receive money, the exchange company directly delivers the foreign currency at the location and time desired by the user.

However, in the case of the conventional online money exchange method mentioned above, there is the advantage of being able to apply online and receive foreign currency at the desired location and time, but the foreign currency can be received only at the designated location and time, also there is a limitation in that a user has to visit the pickup location or meet a currency exchange company to receive foreign currency in a face-to-face manner.

Meanwhile, in order to overcome the problems of the conventional online money exchange method, a method of a non-face-to-face service through a kiosk has been proposed, but there is a problem that money exchange kiosks that can perform non-face-to-face money exchange services have not yet been concretely implemented.

In addition, in the case of providing a non-face-to-face money exchange service through a conventional money exchange kiosk, the money exchange kiosk must be manufactured in a large size to store all the various kinds of foreign currency requested by the user because the exchange kiosk is installed domestically, and in order to provide exchange services for various kinds of foreign currencies, a lot of people and cost to manage the money exchange kiosk are required.

### SUMMARY

### Technical Problem

The present disclosure is invented to solve the problems of the money exchange reservation method using the conventional money exchange kiosk mentioned above, and a purpose of the present disclosure is to provide a method in which a user reserve money exchange before departure through an application installed on user terminal and easily receive money exchange services through a money exchange kiosk installed in the visiting country.

Another purpose of the present disclosure is to provide a method to eliminate the need to carry unnecessary foreign currency change by requesting that a user return the remaining change after spending through a money exchange kiosk installed in the visiting country and to return the remaining change to an account set by the user.

Another purpose to be achieved by the present disclosure is to provide a money exchange reservation method that allow a user to select the receipt type to receive the reserved amount at once through a money exchange kiosk installed in the visiting country or to receive the reserved amount at any time through various money exchange kiosks installed in the visiting country whenever a user wants.

### Solution to Problem

In order to achieve the purpose of the present disclosure, the money exchange reservation method according to the present disclosure is characterized by including a step of receiving reservation request information through a user terminal, a step of informing a money exchange cost according to the reservation information to the user terminal, registering the money exchange reservation information in a database when the money exchange cost is deposited, a step of receiving the money exchange request information from a money exchange kiosk, and a step of controlling a payment of foreign currency reserved to a user through the exchange kiosk by comparing the money exchange reservation information registered in the database of a management server with the exchange request information.

Here, the money exchange kiosk is characterized as a local money exchange kiosk placed in the country visited by a user.

Preferably, the money exchange reservation method according to the present disclosure is characterized in that when a money exchange cost is deposited, a step of generating a money exchange code is further included, and that the money exchange reservation information is generated including a money exchange code.

Here, the money exchange reservation information is registered in a database unit and provided to the user terminal at the same time, or provided to the user terminal when there is a request from the user terminal.

Preferably, the money exchange reservation method according to the present disclosure further includes a step of comparing location information of the money exchange kiosk that received the money exchange request information with a country information in the money exchange reservation information to determine whether the location information of the money exchange kiosk matches the country information and controls a payment of foreign currency reserved to the user depending on whether the location information and the country information match.

Here, the reservation request information includes information about a receipt type of either a one-time receipt type, in which the foreign currency requested by a user is received all at once through the local money exchange kiosk, or a split receipt type, in which a portion of the foreign currency a user has requested exchanged is received through the local money exchange kiosk whenever a user wants.

Here, the money exchange reservation method according to the present disclosure is characterized by calculating an exchange fee differently depending on the receipt type and guiding the exchange cost.

Preferably, the money exchange reservation method according to the present disclosure is characterized by further including a step of receiving return request information from a local money exchange kiosk and a step of calculating return amount based on the return request information and returning the return amount to a user account.

Preferably, the money exchange reservation method according to the present disclosure further includes a steps of receiving return request information from a local money exchange kiosk or a user terminal, a step of determining information on remaining foreign currency that the user has not received among the foreign currency requested for exchange, in the case of a split receipt type, and a step of calculating the refund amount to the user based on the remaining foreign currency information and returning the refund amount to the user account.

Here, the return amount is calculated by considering an exchange fee corresponding to the remaining foreign currency information.

### Advantageous Effects of Invention

The money exchange reservation method according to the present disclosure, by allowing a user to make a money exchange reservation through an application installed on a user terminal before visiting a foreign country, and then to receive a visiting currency needed in the visiting country through a money exchange kiosk provided in the visiting country, enables a user to reduce the cost and effort required to manage and operate money exchange kiosks by providing a money exchange service in the currency of the corresponding county to a user who visits the country while the money exchange kiosk stores only the foreign currency of the corresponding country, and enables a user to do not need to exchange foreign currency in advance or travel with the exchanged money in possession and can use the desired money exchange kiosk at the time of need after arriving in the country.

The money exchange reservation method according to the present disclosure, by returning foreign currency change remaining after use through a money exchange kiosk installed in the visiting country, and then crediting the amount equivalent to the returned foreign currency change to the user account, enables a user to reduce losses caused by unnecessarily possessing foreign currency change after returning to his or her home country because it is impossible to exchange foreign currency change, or by exchanging foreign currency change at a significant discount rate even if exchange is possible.

The money exchange reservation method according to the present disclosure, by receiving the amount reserved for exchange all at once through a money exchange kiosk installed in the visiting country, or by receiving the money in installments whenever a user wants through various money exchange kiosks installed in the visiting countries, enables a user to receive the amount all at once or only part of it whenever necessary depending on his or her choice, thereby reducing the inconvenience and risk that may arise from carrying all the exchanged foreign currency.

Additionally, in order to receive foreign currency in the visiting country, a user must visit a bank before departure, pay a money exchange fee to exchange the currency, and pay a double remittance fee for sending the foreign currency to the bank in the visiting country, but the money exchange reservation method according to the present disclosure, by reserving money exchange before departure through a user terminal and receiving the foreign currency reserved for exchange through a money exchange kiosk placed in the visiting country without having to pay a double exchange fee and remittance fee, enables a user to receive foreign currency in the visiting country with only a money exchange fee.

### BRIEF DESCRIPTION OF THE DRAWINGS

FIG. 1 is a functional block diagram for explaining a money exchange reservation system according to an embodiment of the present disclosure.

FIG. 2 is a diagram for explaining an example of arrangement of money exchange kiosks placed around the world according to the present disclosure.

FIG. 3 is a functional block diagram for explaining an example of a message transmitted and received in a money exchange reservation system.

FIG. 4 is a functional block diagram for explaining a money exchange management server according to an embodiment of the present disclosure.

FIG. 5 is a functional block diagram for explaining a reservation unit according to an embodiment of the present disclosure.

FIG. 6 is a functional block diagram for explaining the money exchange management unit according to an embodiment of the present disclosure.

FIG. 7 is a flowchart for explaining the money exchange reservation method according to the present disclosure.

FIG. 8 is a flowchart for explaining an example of determining whether a money exchange request command is valid in the present disclosure.

FIG. 9 shows an example of a user interface screen for making a money exchange reservation in the present disclosure.

FIG. 10 shows an example of a user interface screen for providing a money exchange service in the present disclosure.

FIG. 11 is a flowchart for explaining an example of a method for a user to request a return of foreign currency remaining after use in a visiting country.

### DETAILED DESCRIPTION OF EMBODIMENTS

In the present disclosure, it should be noted that the technical terms are only used to describe specific embodiments and are not intended to limit the present invention. In addition, the technical terms used in the present disclosure, unless specifically defined differently in the present invention, should be interpreted as meanings generally understood by a person skilled in the art to which the present disclosure pertains, and are not overly comprehensive or overly narrow sense. Additionally, if the technical terms used in the present disclosure are incorrect technical terms that do not accurately express the idea of the present disclosure, it should be replaced with a technical term that can be correctly understood by a person skilled in the relevant field of technology.

Additionally, singular expressions used in the present disclosure include plural expressions unless the context clearly dictates otherwise. In the present disclosure, terms such as “consists of” or “comprises” should not be interpreted as necessarily including all of the various components or steps described in the disclosure, and it should be interpreted that some of the components or steps may not be included, or additional components or steps may be included.

In addition, it should be noted that the attached drawings are only intended to facilitate easy understanding of the concepts of the present disclosure, and should not be construed as limiting the concepts of the present disclosure by the attached drawings.

A money exchange reservation method according to the present disclosure will be described below with reference to the attached drawings.

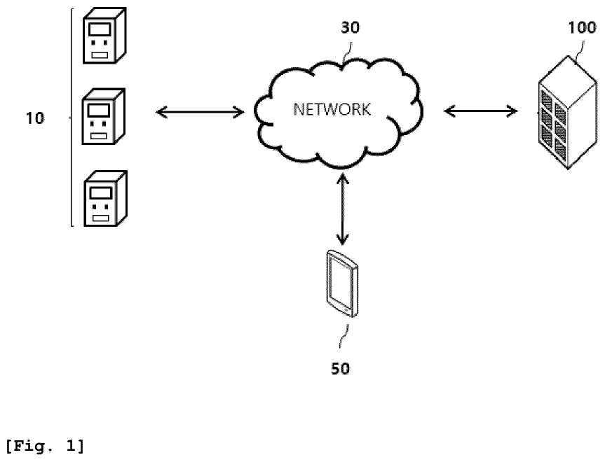

FIG. 1 is a functional block diagram for explaining a money exchange reservation system according to an embodiment of the present disclosure.

Describing more specifically with reference to FIG. 1, a plurality of money exchange kiosks (10), user terminals (50), and money exchange management server (100) are connected to a network (30).

Here, the network (30) may be a variety of wired or wireless networks capable of transmitting and receiving data between a plurality of money exchange kiosks (10), the user terminal (50), and the money exchange management server (100).

The money exchange kiosk (10) is a kiosk that provides a user with foreign currency that the user has requested to exchange, and at least one money exchange kiosk (10) is installed in a distributed manner for each city in each country.

The user uses the user terminal (50) to access the money exchange management server (100) and requests a money exchange reservation service, and the user terminal (50) may be various types of terminals that can download and install a dedicated application, run the application, and request a money exchange reservation service to the money exchange management server (100).

When receiving a money exchange reservation request command from the user terminal (50), the money exchange management server (100) checks whether a money exchange fee has been deposited and then registers the money exchange reservation information in a database unit, and when the money exchange request command is received through a money exchange kiosk installed in the visiting country by the user, after determining the validity of the money exchange request command, the money exchange service is provided to the user through the money exchange kiosk.

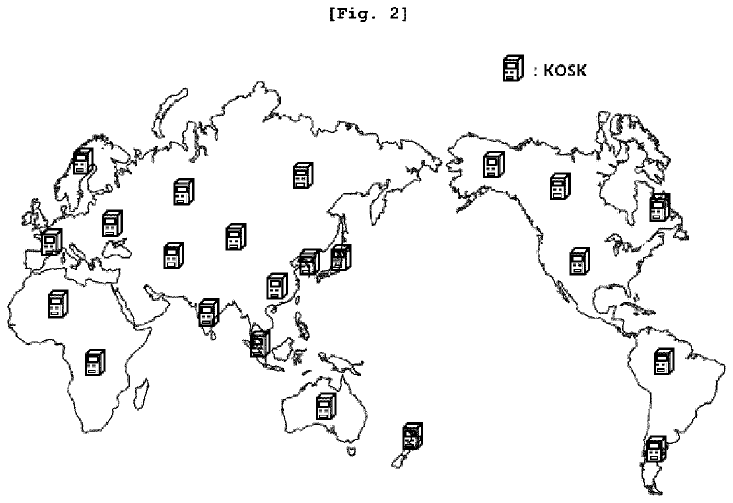

FIG. 2 is a diagram for explaining an example of arrangement of money exchange kiosks placed around the world according to the present disclosure.

As shown in FIG. 2, at least one money exchange kiosk is distributed in multiple cities and multiple countries. Therefore, when a user arrives in the visiting country, the user receives money exchange services through a money exchange kiosk placed at the location specified at the time of reservation, or the user can receive money exchange services by searching for money exchange kiosks placed close to his or her current location.

The money exchange reservation method according to the present disclosure has advantages that, from the perspective of a user, the user requests to exchange the foreign currency of the visiting country in advance through the user terminal, and after the user arrives at the visiting country, the user can conveniently exchange all or only part of the requested foreign currency at a designated time or at a time desired by the user through a money exchange kiosk located in the visiting country, and from the perspective of a kiosk operator, it is convenient to manage and operate the money exchange kiosk in the visiting by providing money exchange services by placing only the currency of the visiting country or some key currencies in the exchange kiosk.

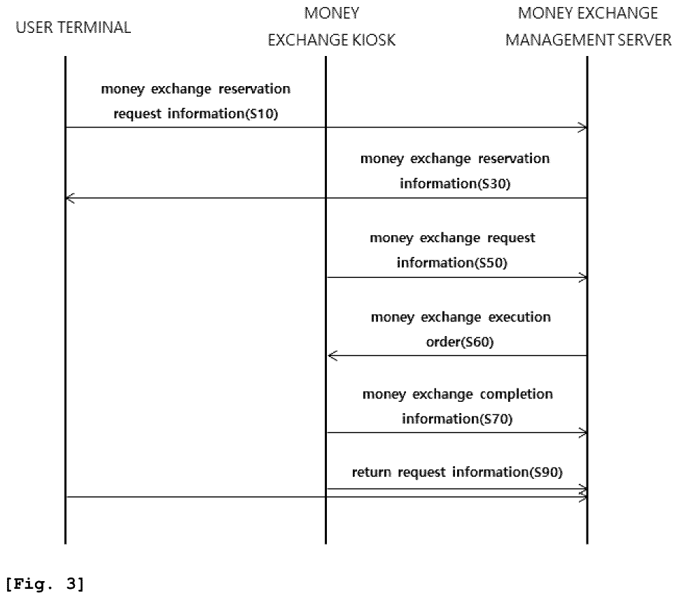

FIG. 3 is a functional block diagram for explaining an example of a message transmitted and received in a money exchange reservation system.

Describing more specifically with reference to FIG. 3, a user terminal transmits a money exchange reservation request message to the money exchange management server (S10). Here, the money exchange reservation request message includes information such as the country that a user will visit, exchange amount, quantity of each foreign currency denomination, and a receipt type.

The money exchange management server responds to the money exchange reservation request message and checks whether the money exchange cost has been deposited, and then if the money exchange cost has been deposited, the money exchange management server transmits the money exchange reservation information to the user terminal (S30). The money exchange reservation information may include a money exchange code to be used when using the money exchange reservation service in the future.

When a user requests a money exchange service through a money exchange kiosk after arriving in the visiting country, the money exchange kiosk transmits a money exchange request message to the money exchange management server (S50), and in response to the money exchange request message, the money exchange management server transmits a money exchange execution message to the money exchange kiosk (S60). Here, the money exchange request message includes a money exchange code, and it can be determined whether the money exchange request message is valid based on the money exchange code.

When the money exchange service requested by the user is completed, that is, when the foreign currency requested by the user has been paid through the money exchange kiosk, a money exchange completion message is received from the money exchange kiosk (S70).

Afterwards, if the user has a plan to leave the visiting country, a return request message is received to return the foreign currency remaining after spending in the visiting country (S90). The user can request a return of foreign currency remaining after spending in the visiting country by directly inserting the remaining foreign currency into a money exchange kiosk, or if there is remaining foreign currency that has not yet been received through a money exchange kiosk placed in the visiting country, the user can request a return through the user terminal. When the money exchange management server receives a return request message, foreign currency requested for return can be returned to a user account set according to an exchange rate.

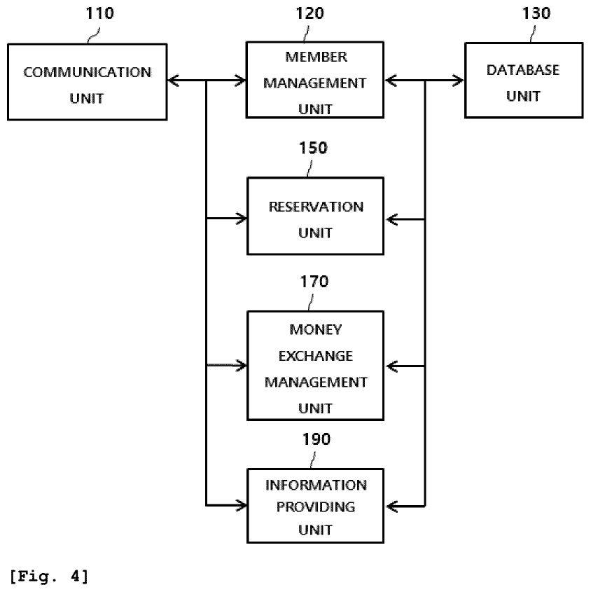

FIG. 4 is a functional block diagram for explaining a money exchange management server according to an embodiment of the present disclosure.

Describing more specifically with reference to FIG. 4, the money exchange management server provides a money exchange reservation service to a user by communicating with a user terminal, or provides a money exchange service to the user by communicating with a money exchange kiosk, and the money exchange management server is provided with a communication unit (110) for transmitting and receiving data with a user terminal or a money exchange kiosk. Here, the communication unit (110) may perform communication using various wired or wireless communication protocols, and the communication unit (110) may transmit and receive data using the same communication method as a user terminal and a money exchange kiosk, or may transmit and receive data using a different communication method.

When receiving membership registration information from a user terminal, a member management unit (120) divides the received membership registration information by user and then registers and stores the received membership registration information in a database unit (130). Here, the membership registration information may include user information such as a name of a user, gender, and address, and login information such as ID and password.

After a user enters login information and connects to the money exchange management server, the money exchange reservation request information or the money exchange reservation information is classified into the membership registration information and then stored and registered in the database unit (130).

When receiving reservation request information from the user terminal, a reservation unit (150) guides a user terminal to a money exchange cost calculated based on the reservation request information, and when the money exchange cost is deposited, the money exchange reservation information is generated, and then the generated exchange reservation information is stored and registered in the database. Additionally, the reservation unit (150) provides the generated money exchange reservation information to the user terminal through the communication unit (110).

Meanwhile, when a money exchange request command is received from a money exchange kiosk, a money exchange management unit (170) controls payment of money exchange amount requested by a user on the money exchange kiosk according to the money exchange request command, or when a return request command is received from a money exchange kiosk or a user terminal, the money exchange management unit (170) controls to return the remaining foreign currency after spending in the visiting country to an account set by a user according to the return request command.

An information providing unit (190) may provide information to the user or the manager of the money exchange kiosk by communicating with the money exchange kiosk or the user terminal through the communication unit (110). For example, the information providing unit (190) provides information about available dates on which money can be exchanged based on money exchange reservation information, information about the remaining exchange balance or information about location of money exchange kiosks placed adjacent to a specific area. For example, the information providing unit (190) monitors the foreign currency amount filled in the money exchange kiosk and provides alarm information to the manager of the money exchange kiosk when the foreign currency amount is less than the set amount, or the information providing unit (190) provides money exchange reservation information by time, date, or week for each money exchange kiosk. The information providing unit (190) monitors if a large amount of money exchange reservations are made to a specific money exchange kiosk on a specific day, and if a money exchange reservation is assigned to a specific money exchange kiosk in excess of the preset reservation amount or number of reservations set. The manager of the money exchange kiosk can prevent users from not receiving money exchange services by pre-arranging the exchange amount to a specific money exchange kiosk based on alarm information.

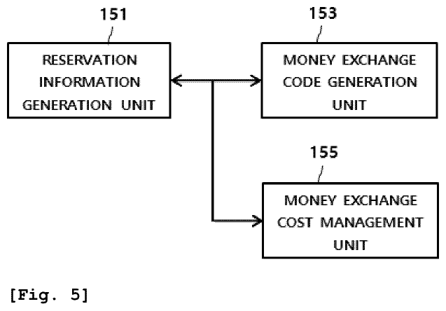

FIG. 5 is a functional block diagram for explaining a reservation unit according to an embodiment of the present disclosure.

Describing more specifically with reference to FIG. 5, a money exchange cost management unit (155) calculates exchange cost according to the exchange amount, the type of foreign currency requested by a user, the quantity of each foreign currency denomination, and the exchange rate of the foreign currency and so on, and then inform the exchange cost to a user terminal. The money exchange cost management unit (155) checks whether the money exchange cost has been deposited, and when the money exchange cost has been deposited, the money exchange cost management unit (155) notifies a reservation information generation unit (151) that the deposit of the money exchange cost has been completed.

Preferably, the exchange cost management unit (155) may calculate the exchange cost, especially the exchange fee, differently based on receipt types among reservation request information received from a user terminal and provide guidance. Here, the receipt type is a type in which a user arrives at a visiting country and receives the foreign currency requested for exchange through a money exchange kiosk located in the visiting country, and the receipt types can be divided into a one-time receipt type that a user arrives at a visiting country and receive the entire amount requested for exchange at once through a money exchange kiosk and a split receipt type that a user arrives at the visiting country and receive the amount requested for exchange through a money exchange kiosk placed in the visited country, whenever a user needs it.

When selecting the one-time receipt type, a user has the inconvenience of having to receive entire amount at once through an exchange kiosk located in a visiting country after arriving in the visiting country, but the exchange fee is relatively lower compared to the split receipt type, and when selecting the split receipt type, a user can conveniently receive some or all of the amount after arriving in the visiting country whenever necessary, depending on his or her choice, through a money exchange kiosk located in the visiting country, but the money exchange fee must be paid at a relatively higher compared to the one-time receipt type.

Additionally, when selecting the split receipt type, the currency exchange kiosks where the user can receive services in the visiting country can be limited to a specific city, but it can be set to currency exchange kiosks located throughout all of the visiting countries. If the currency exchange kiosk that can receive the service in the split receipt type is set as currency exchange kiosks located throughout all of the visiting countries, the currency exchange fee can be set relatively high compared to a currency exchange fee limited to a currency exchange kiosk located in a specific city.

When making a money exchange reservation, a user can conveniently receive money exchange service by selecting a receipt type or location of a money exchange kiosk to receive the service, taking into account the purpose of travel or destination of a country, and a money exchange kiosk managers can receive fair payment based on the quality of the money exchange service.

A money exchange code generation unit (153) generates a money exchange code that can only be used for the relevant money exchange reservation information to identify the money exchange reservation information. Here, the money exchange code may be a code composed of a combination of multiple numbers, letters, and special symbols, or may be an encryption code such as a barcode or QR code.

When a money exchange cost is deposited, the reservation information generation unit (151) generates money exchange reservation information from the reservation request information, the money exchange fee deposit information, and the money exchange code, and then the generated money exchange reservation information is registered and stored in a database, and at the same time, the money exchange reservation information is transmitted to a user terminal. Based on the money exchange reservation information, a user can check whether the money exchange reservation has been made exactly as the user requested the money exchange reservation, and then after arriving at a visiting country, the user can receive money exchange services through a money exchange kiosk based on the money exchange reservation information.

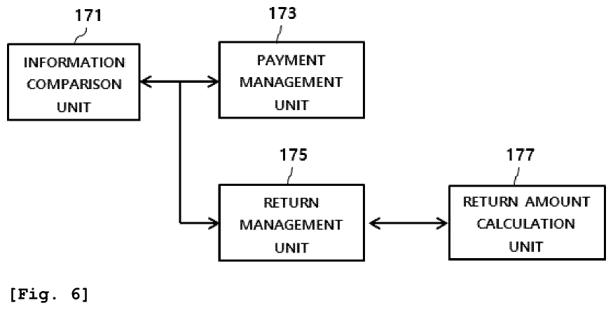

FIG. 6 is a functional block diagram for explaining a money exchange management unit according to an embodiment of the present disclosure.

Describing more specifically with reference to FIG. 6, when receiving money exchange request information through a money exchange kiosk, an information comparison unit (171) determines whether the money exchange request is valid by comparing the money exchange request information with the money exchange reservation information registered in the database unit, or when receiving the return request information from a money exchange kiosk or a user terminal, the information comparison unit (171) determines whether the return request is valid by comparing the return request information with the money exchange reservation information. Here, when requesting to return foreign currency remaining after use in the visiting country directly through a money exchange kiosk, whether the return request is valid can be determined by whether the foreign money exchange kiosk is located in the visiting country based on the location information of the money exchange kiosk or whether the foreign currency requested to be returned is the foreign currency of the country the user is visiting. Additionally, when requesting the return of foreign currency remaining after use through the user terminal, whether the return request is valid can be determined by whether the receipt type is a split receipt type and whether the user information requesting return matches the user information requesting exchange.

If the money exchange request is valid, a payment management unit (173) controls payment of the money exchange amount requested by a user through the money exchange kiosk that has received the money exchange request information. When receiving a message about receipt completion from the money exchange kiosk, the payment management unit (173) updates the money exchange reservation information in the database unit based on the receipt type. That is, in the case of a one-time receipt type, the receipt information is updated from ‘before receipt’ to ‘completed receipt’ in the exchange reservation information. In the case of a split receipt type, the exchange reservation information is updated by deducting remaining exchange amount from the received exchange amount.

Meanwhile, if the return request is valid, a return management unit (175) exchanges the remaining foreign currency after spending in the visiting country back into the foreign currency that the user used when exchanging money, or converts the remaining foreign currency into points or virtual currency and returns it to the user account set. Here, a return amount calculation unit (177) calculates refund amount and provides the calculated refund amount to the return management unit (175), and the return amount calculation unit (177) can calculate the return amount based on the exchange rate when a return is requested.

Preferably, the return amount calculation unit (177) may calculate return fee differently based on the time of the return request when requesting a return of foreign currency remaining after using in the visiting country through the user terminal as a split receipt type.

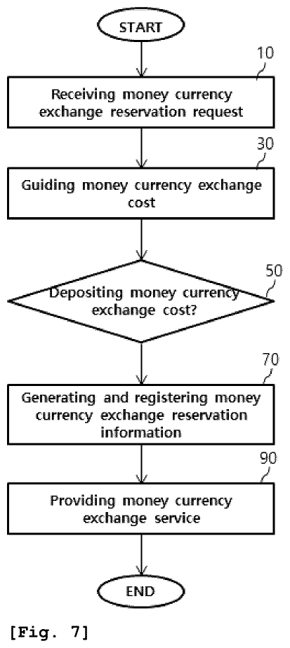

FIG. 7 is a flowchart for explaining money exchange reservation method according to the present disclosure.

Describing more specifically with reference to FIG. 7, the money exchange management server receives money exchange reservation request information from a user terminal (S10). Here, the money exchange reservation request information includes a name of a user, contact information, ID and identifier, type of foreign currency, exchange request amount, quantity of each foreign currency denomination, country or city, visit date, visit period, and receipt type.

When receiving the money exchange reservation request information, the money exchange cost is calculated based on the money exchange reservation request information and the calculated money exchange cost is guided to the user terminal (S30). Here, the money exchange cost includes a money exchange fee, which may be calculated differently depending on a receipt type and a period of visit. For example, in the case of the split receipt type, the exchange fee is relatively more expensive than the one-time receipt type, and in the case of the split receipt type, the longer the visit period, the more expensive the money exchange fee may be calculated.

After determining whether the exchange cost informed to a user terminal has been deposited (S50), and if it is confirmed that the exchange cost has been deposited, exchange reservation information is generated, and the generated exchange reservation information is registered in the database and simultaneously transmitted to the user terminal (S70). The money exchange cost must be deposited within the set valid period, and if the money exchange cost is not deposited by the effective deposit period, the money exchange reservation request may be canceled.

When a user arrives at a visiting country and requests money exchange through a money exchange kiosk placed in the visiting country, a control command is provided to the money exchange kiosk to provide a money exchange service to the user through the money exchange kiosk (S90). For example, a user may request money exchange by entering or reading a money exchange code at a money exchange kiosk. If the one-time receipt type is set based on the receipt type mapped to the exchange code, payment is controlled so that the user receives the entire amount, and if the split receipt type is set, payment of the requested amount can be controlled so that the user receives the amount requested by the user out of the total amount requested for exchange.

Preferably, when the money exchange code is entered or read at the money exchange kiosk, the payment information is continuously activated on the interface screen. In the case of the one-time receipt type, a message is displayed on the payment information interface screen to inform a user that the entire reserved money exchange amount and the entire money exchange amount will be paid at once, and in the case of the split receipt type, the payment information interface screen displays the entire reserved exchange amount, the remaining exchange amount, and the input items for entering the exchange amount a user wants to receive among the remaining exchange amount.

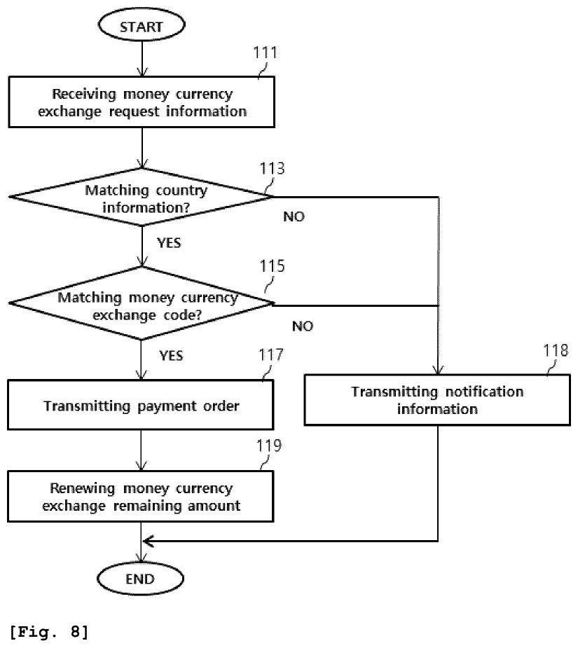

FIG. 8 is a flowchart for explaining an example of determining whether a money exchange request command is valid in the present disclosure.

Describing more specifically with reference to FIG. 8, when a money exchange request command is received from a money exchange kiosk (S111), the location information of the money exchange kiosk that received the money exchange request command is compared with the visiting country information among the money exchange reservation information, and whether the location information of the money exchange kiosk matches the country information is determined (S113).

If the location of the money exchange kiosk and the country information match each other, it is determined whether a money exchange code matching the code entered or read through the money exchange kiosk exists in the database of the money exchange management server (S115). Preferably, the ID or password is first entered into the money exchange kiosk, and then the money exchange code is entered or read. The user corresponding to the ID or password is searched and then it can be determined whether there is a money exchange code that matches the entered money exchange code among the money exchange codes assigned to the searched user.

If the money exchange code matches, a payment command is sent to the money exchange kiosk to pay the amount requested by the user according to the receipt type selected by the user (S117), and when a receipt completion message is received from the money exchange kiosk, the money exchange reservation information is updated (S119). In other words, if the receipt is completed in a one-time receipt type, the exchange reservation information is updated as receipt completed. If the receipt is completed in a split receipt type, the remaining exchange amount is updated by subtracting the requested exchange amount from the currently remaining exchange amount.

Meanwhile, if the location of the money exchange kiosk that received the money exchange request order and the country information among the money exchange reservation information are different, the money exchange kiosk will notify a user that it is not the money exchange kiosk of the country a user selects or notify a user that money exchange is not possible through the money exchange kiosk (S118). In addition, if the exchange code that matches the exchange code entered in the exchange kiosk is not mapped to the user, notification information indicating that the money exchange service is not possible because the money exchange code is incorrect is sent to the money exchange kiosk (S118).

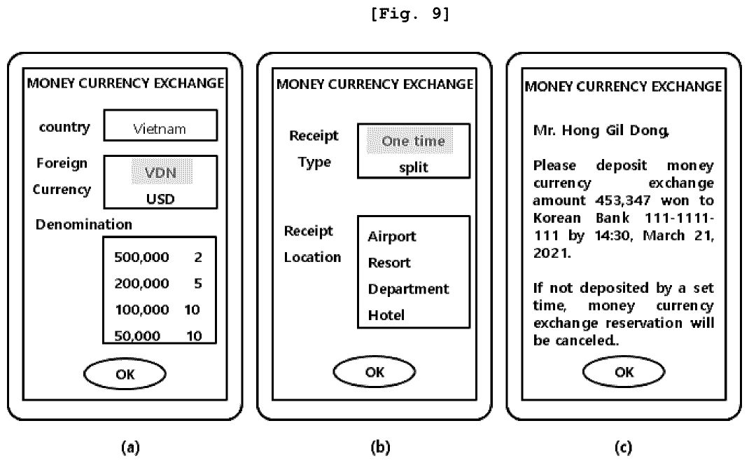

FIG. 9 shows an example of a user interface screen for making a money exchange reservation in the present disclosure.

As shown in FIG. 9(a), enter the country a user is visiting (Vietnam), the type of foreign currency a user wants to exchange, and the quantity of each foreign currency denomination a user wants to exchange.

As shown in FIG. 9(b), enter the receipt type whether a user wants to receive a foreign currency requested for exchange in a visiting country all at once or in split when necessary, and select receipt location from city, airport, resort, hotel and so on.

As shown in FIG. 9(c), when all money exchange reservation request information is entered, an interface screen is activated on a user terminal to guide a user to deposit the calculated money exchange cost by the set date.

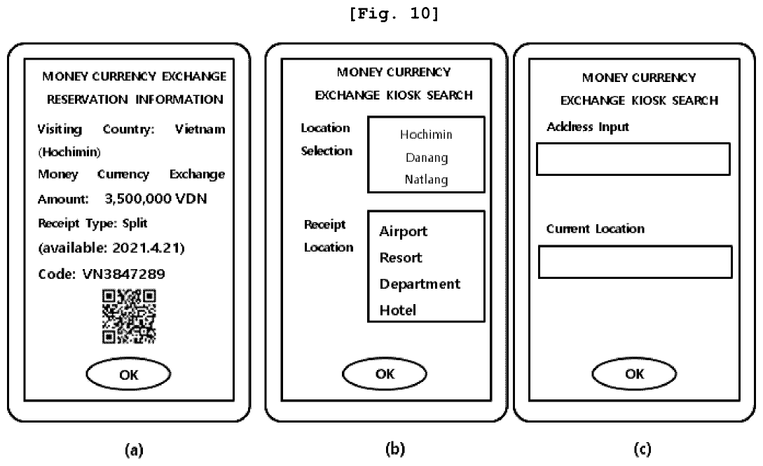

FIG. 10 shows an example of a user interface screen for providing a money exchange service in the present disclosure.

When a money exchange cost is deposited, money exchange reservation information including a money exchange code is generated and transmitted to a user terminal. FIG. 10(a) shows an example of the money exchange reservation information. A user can check money exchange reservation information through a user terminal. Preferably, a user can access the money exchange management server to obtain money exchange reservation information.

FIGS. 10(b) and 10(c) are an example of a user interface screen for a user to search for a money exchange kiosk in a visiting country. A user can search for money exchange kiosks by entering a city and a pickup location in that city, or a user can search for nearby money exchange kiosks by entering desired address or current address.

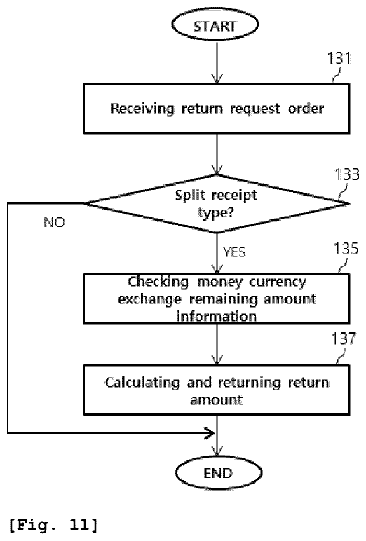

FIG. 11 is a flowchart for explaining an example of a method for a user to request a return of foreign currency remaining after use in a visiting country.

Referring to FIG. 11, in the case of a return request command received through a user terminal (S131), it is checked whether a user has set a receipt type to a split receipt type when requesting money exchange (S133).

Only if it is set to a split receipt type, remaining exchange balance amount among the total exchange amount is checked (S135), and then refund amount is calculated from the confirmed exchange balance amount, and the calculated return amount is returned to a user account. (S137).

Here, when calculating the return amount, a return fee can be calculated differently. If an exchange request is made in a split receipt type, a user can receive a portion of the foreign currency as desired at the time needed in a visiting country, and remaining foreign currency after spending in a visiting country can be returned in a visiting country or a user can request remaining foreign currency returned after leaving the country. A return fee is the same when requesting a return while a user stays in a visiting country or during the preset period after requesting money exchange, but if a user leaves a visiting country or the preset period has elapsed, a return fee may increase to correspond to the elapsed period.

Meanwhile, the above-described embodiments of the present disclosure can be written as a program that can be executed on a computer, and can be implemented in a general-purpose digital computer that operates the program using a computer-readable recording medium.

The computer-readable recording media include storage media such as magnetic storage media (e.g., ROM, floppy disk, hard disk, etc.), optical read media (e.g., CD-ROM, DVD, etc.), and carrier wave (e.g., transmission via Internet).

The present disclosure has been described with reference to the embodiments shown in the drawings, but these are merely exemplary, and those skilled in the art will understand that various modifications and other equivalent embodiments are possible therefrom. Therefore, the true technical protection scope of the present disclosure should be determined by the technical concept of the attached registration claims.

What is claimed is:

1. A money currency exchange reservation method of performing money currency exchange reservation in a money currency exchange management server, the method comprising:
receiving money currency exchange reservation request information through a user terminal;
informing a user terminal of a money currency exchange cost according to the money currency exchange reservation request information, and registering money currency exchange reservation information in a database unit when deposit of the money currency exchange cost is completed;
receiving money currency exchange request information from a money currency exchange kiosk; and
control payment of foreign currency reserved for currency exchange to a user through the money currency exchange kiosk by comparing the money currency exchange reservation information registered in the database unit of the money currency exchange management server and the money currency exchange request information.

2. The money currency exchange reservation method according to claim 1,
wherein the money currency exchange kiosk is a local money currency exchange kiosk located in a foreign country visited by the user.

3. The money currency exchange reservation method according to claim 2,
further comprising generating a money currency exchange code when the deposit of the money currency exchange cost is completed,
wherein the money currency exchange reservation information is generated by including the money currency exchange code.

4. The money currency exchange reservation method according to claim 3,
wherein the money currency exchange reservation information is provided to the user terminal at the same time as being registered to the database unit, or provided to the user terminal when there is a request from the user terminal.

5. The money currency exchange reservation method according to claim 4,
further comprising, by comparing location information of the money currency exchange kiosk receiving the money currency exchange request information with country information included in the money currency exchange reservation information, determining whether the location information of the money currency exchange kiosk matches the country information,
wherein the payment of the foreign currency reserved for the currency exchange to the user is controlled according to whether the location information of the money currency exchange kiosk matches the country information.

6. The money currency exchange reservation request information according to claim 5, wherein the money currency exchange reservation request information includes
information about one of receipt types including a one-time receipt type receiving all of the foreign currency requested for the currency exchange by the user at once through the local money currency exchange kiosk and a split receipt type receiving a portion of the foreign currency through the local money currency exchange kiosk when the user desires.

7. The money currency exchange reservation method according to claim 6,
guiding the money currency exchange cost by calculating the money currency exchange cost differently according to the one of the receipt types.

8. The money currency exchange reservation method according to claim 6, further comprising:
receiving return request information from the local money currency exchange kiosk; and
calculating a return amount based on the return request information and returning the refund amount to an account of the user.

9. The money currency exchange reservation method according to claim 6, further comprising:
receiving return request information from the local money currency exchange kiosk or the user terminal;
determining whether one of the receipt types of the foreign currency requested for the currency exchange by the user is the split receipt type;
when the one of the receipt types of the foreign currency requested for the currency exchange by the user is the split receipt type, determining information on remaining foreign currency which has not been received among the foreign currency requested for the currency exchange by the user;
calculating return amount to the user based on the information on the remaining foreign currency and returning the return amount to an account of the user.

10. The money currency exchange reservation method according to claim 9, wherein the return amount is
calculated by considering a money currency exchange fee corresponding to the information on the remaining foreign currency.
